(19) United States
(12) Patent Application Publication
(10) Pub. No.: US 2009/0048890 A1
(43) Pub. Date: Feb. 19, 2009

(54) Delivery Management System for Quick Service Restaurants

(76) Inventor: Stuart G. Burgh, Ann Arbor, MI (US)

Correspondence Address: Griffin Burgh, 1725 Stonebridge Dr. S., Ann Arbor, MI, 48108, US

(21) Appl. No.: 11/839,751

(22) Filed: Aug. 16, 2007

(51) Int. Cl. G06Q 10/00

(52) U.S. Cl. 705/8

(57) ABSTRACT

A geographic database of the subject invention interfaces with the Point-of-Sale system in a Quick Service Restaurant to optimize the sequence and pairing of delivery orders based on customer location, driver availability and prioritized real-time information.

The system optionally communicates with GPS-enabled cellular or Wi-Fi communication devices to provide turn-by-turn navigation information to the driver and enable supplementary location information and other communication exchanges between the driver and the dispatch location during the delivery process.

The system may be configured to aggregate a number of local delivery areas into a virtualized delivery system allowing further optimization of driver resources and to enhance capacity utilization across participating order-dispatch locations.

### CROSS-REFERENCE TO RELATED APPLICATIONS

This application claims the benefit of the priority of the following provisional applications:

“Improved Method for Workflow Optimization”, Application No. 60/839,893, filed Aug. 24, 2006

This provisional application is hereby incorporated by reference in their entireties.

### USE OF FEDERAL FUNDS

No Federal funds have been used for any part of the present invention.

### BACKGROUND OF THE INVENTION

1. Field of the Invention

The present invention relates to methods to improve the efficiency off-premises food delivery for quick service restaurants (QSR) and pizza parlors though networking retail point-of-sale information together with geographic databases, GPS navigation systems, wireless communication systems, and the Internet.

2. Description of the Related Art

Quick Service Restaurants (QSR) offering home-delivery are highly competitive within local markets and frequently operate with slim profit margins due to high labor, overhead and raw materials costs. Operating these stores with a surplus of staff, equipment and delivery drivers may achieve high customer-satisfaction levels at the cost of profitability. With significant increases to transportation fuel costs and substantial increases to minimum wage labor rates recently, store operators are seeking to optimize the production and delivery process and take cost out of the system. Significant savings can be achieved by dispatching a higher percentage of orders as double or multiple-delivery runs, thus reducing allocated driver costs and reducing fuel consumption, however, this must be done very precisely to minimize delivery delays which would otherwise decrease customer satisfaction metrics.

While manual production and dispatch methods in common use among operators, the manual methods frequently fail to achieve the optimal production balance due to the complexity of calculating the relevant real-time variables. This can result in failing to have adequate staffing resources on hand; having too many resources available; failing to optimally associate orders that might be delivered more profitably as multiple-delivery runs; or by creating bottlenecks at various stages of the production or delivery process.

Numerous automated systems and methods have heretofore been disclosed for optimizing food production and fleet-management and vehicle delivery activities based on geo-database analysis and GPS navigational guidance. For example, many of the fleet management systems are based on variations of the “Traveling Salesman” problem which assumes a static list of delivery locations according to customer orders from a previous time period. Unlike fleet-management logistics, however, the routes required for QSR product delivery are highly dynamic and require recursive real-time analysis as the order queue and available driver resources are constantly changing. The peak delivery times for QSR's during the lunch and dinner hours add further complexity to the requirements. Typical fleet logistics applications fail to identify the relevant production and delivery variables impacting QSR operators. Moreover, the previous art related to GPS delivery optimization fails to fully integrate all of the required components necessary to achieve workforce reduction, or erroneously focus on reducing customer wait time rather than reducing driver staffing requirements.

U.S. Pat. No. 5,648,770, assigned to Rose, provides a system for notifying a party of a pending delivery or pickup of an item. The disclosed system compares the location of a mobile vehicle to the location of the customer receiving the delivery or pickup. When the vehicle is within a predetermined distance or within a predetermined interval time from the pickup/delivery location, the system sends a notification to the customer of the pending vehicle arrival. While the customer notification may be useful for the customer, the disclosure fails to identify how driver “at-door” wait time can be reduced and therefore only indirectly addresses but a single aspect of the problems identified above.

U.S. Pat. No. 6,026,375, issued to Hall et al., provides a system that enables service providers to receive an order from a mobile customer, receive customer location information from a location determination system, and schedule the completion of the customer's arrival at a local facility able to satisfy the order. The service provider uses the customer's location to determine a local facility that can satisfy the customer's order, but fails to identify provisions for optimizing production resources in the order fulfillment process.

U.S. Pat. No. 7,228,225, issued to Walters et al., provides an API interface method to more quickly associate a particular wireless network communication device with a navigation database, but does not disclose methods for how such time-savings on the software development side will impact QSR owner profitability.

QSR operators employ specific food preparation stages which include, for example; order entry, order preparation, baking, and final order assembly, followed by racking or warmed staging pending the removal of the final order by the driver for local delivery.

Further, different types of products require different baking times such as 5:30 minutes for a small single topping thin-crust pizza as compared with 8:30 minutes for a large multi-topping deep-dish item. To improve overall efficiency, the queue processing for individual items within an order can be adjusted to coordinate the production of completed orders based delivery priority as determined by routing analysis. A system and method to analyze the weighted impact of these dynamic variables and guide human operators to improved decision-making is not fully developed in prior art.

Accordingly, there remains an unmet need for a system and method which addresses the specific requirements of QSR operators and which provides the necessary optimization of production and delivery methods required to reduce cost while maintaining acceptable levels of customer satisfaction.

### BRIEF SUMMARY OF THE INVENTION

A system and method for Delivery Management is disclosed that provides for the reduction of driver resources needed to deliver a given number of customer orders utilizing order-queue calculations and GPS-based driver status information. As each order is entered into the store's Point Of Sale System, the present invention evaluates preparation time and delivery information together with driver availability and store volume to maximize the number of multiple-delivery runs such that the best operational efficiency is achieved while maintaining high customer-satisfaction levels. The system may be further refined by deploying GPS devices with drivers to provide turn-by-turn navigation (and improve ETA estimates), and by optionally incorporating real-time traffic, weather and construction information. The present invention also disclosed methods for aggregating adjacent affiliated delivery zones to improve order-delivery at the perimeters of the demised delivery area, providing delivery information to customers via the Internet, and reporting methods to predict future staffing requirements based on fully optimized operations.

### BRIEF DESCRIPTION OF THE DRAWINGS

While the invention is claimed in the concluding portions hereof, preferred embodiments are provided in the accompanying description which may be best understood in conjunction with the accompanying diagrams where like parts in labeled with like numbers.

FIG. 1 schematically illustrates the system of the present invention depicting a single delivery driver's GPS device A, representing a plurality of delivery drivers in simultaneous communication with the network system. Geo-location information for each driver may be provided to the network through GPS-derived data or by triangulation methods intrinsic to the wireless network antennas in either cellular network form or by WiMAX or other similar 802.X wireless communication specification (B). Node (C) represents the network server of the invention which is in communication with all remote resources via the Internet (D), thereby connecting to the in-store computer display to share delivery management information (Store E, Store F).

FIG. 2 provides a schematic representation of a store's delivery area and depicts the nodal points for a computational efficient pairing of multiple-delivery runs as described below, where (4) represents the delivery store, 1,2,3 represent specific delivery locations and where the grid schematically represents intersections one minute driving time apart.

FIG. 3 discloses the result of an iterative computational method for determining the mileage-based or time-based route adjacency array as best pairing of delivery addresses using mileage described further below.

FIG. 4 illustrates a representative production line for a quick service restaurant offering off-site delivery services. Orders are taken by phone or over the Internet and entered into the Point of Sale system where they begin the production leading to off-site delivery. This figure is used for a work-flow example described further below.

FIG. 5 illustrates a representative production line for a quick service restaurant offering home delivery services. Orders are typically taken by phone or over the Internet and entered into the Point of Sale system where they begin the production movement of the order through the production capacity. Parameters for each variable, together with driver availability data, are modeled in the rules engine of the subject invention.

FIG. 6 depicts a flow chart of the subject invention showing the schematic interrelationship between the in-store processor, the remote data stores necessary to obtain driver availability information, calculate routing, and ad to deliver optimized workflows.

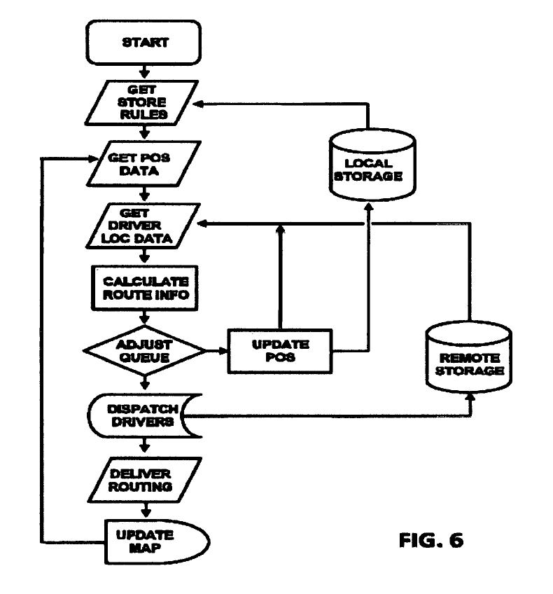

FIG. 7 depicts four orders (A&B) from two adjacent affiliated stores that might exchange order (B) with the sister to reduce delivery cost provided such deliveries are completed within the delivery time rules of both stores.

FIG. 8 depicts the route of a particular driver on a two-delivery run. The route can be viewed “pre-flight” by the driver just prior to leaving the store.

FIG. 9 depicts the in-store display showing driver locations and delivery destinations. The second item in the order queue to the left is a “Dynamap” delivery whose location will be verified and permanently stored for later use.

FIG. 10 depicts a detail of the in-store monitor showing the dynamic ticker bar which displays driver order assignments and estimated return time. Drivers that employ GPS devices will display precise return times, and whose use also improves the accuracy of the dispatch analysis.

FIG. 11 depicts a representative navigation display for a GPS device. In the preferred embodiment, large graphics rather than a map are presented so as not to distract the driver with map interpretation tasks while driving. Verbal turn-by-turn instructions are also provided in the driver's gender and language of choice.

FIG. 12 depicts the “walking map” of the present invention that automatically displays when the driver reaches the proximate delivery location. In this embodiment is depicted the symbol (V) indicating that this address has been verified with a previous delivery. Also displayed are previously stored “MapTracks” of the exact delivery-door location as an offset from the geographic gateway address.

FIG. 13 depicts information displayed for the driver after an emergency key has been pressed on the GPS device. When the driver selects the desired emergency service (i.e. 1, 2, 3, 4), the subject invention automatically provides verbal and graphical navigation directions to the destination.

FIG. 14 depicts one embodiment of reporting output that provides driver and customer delivery metrics, together with predictive staffing that may be employed by store management for driver work schedules.

### DETAILED DESCRIPTION OF THE INVENTION

The following description is presented for the purposes of illustration and description. It is not intended to be exhaustive or to limit the invention to exemplary embodiments disclosed. Many modifications and variations are possible in the light of following teachings. It is intended that the scope of the invention be limited not by this detailed description of exemplary embodiments, but rather by the novelty conception. The general purpose of the present invention, which will be described subsequently in greater detail, is to provide a comprehensive solution to the problem of removing cost from the delivery process while improving customer retention and increasing driver safety. To attain these objectives, the present invention generally comprises (1) the identification of specific orders to be delivered by each driver on each delivery run based on route and delivery adjacency, order volume, and driver availability; (2) the order-item preparation “make-line” sequencing based on driver dispatch times, (3) optional GPS driver navigation to each delivery location with the ability to save and display unique geographical information, (4) a system and method for augmenting driver safety, (5) a reporting system with predictive driver staffing requirements, and (6) the nomination of orders at the perimeter of the delivery area to be produced and delivered by adjacent in-system stores when certain capacity or paired-delivery criteria are met.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of similar computer networks, methods and systems for carrying out the several purposes of the present invention. It is important, therefore, that the claims be regarded as including such equivalent constructions insofar as they do not depart from the spirit and scope of the present invention. Further, the purpose of the foregoing abstract is to enable the U.S. Patent and Trademark Office and the public generally, and especially the software engineers and QSR managers in the industry of the art who are not familiar with patent or legal terms or phraseology, to determine quickly from a cursory inspection the nature and essence of the technical disclosure of the application. The description is neither intended to define the invention of the application, which is measured by the claims, nor is it intended to be limiting as to the scope of the invention in any way.

It is therefore an object of the present invention to provide a multi-faceted solution to the problem of reducing overall QSR delivery expense while maintaining customer loyalty and enhancing driver safety. In so much as the customer's ideal state is to deliver each customer order to the delivery location immediately upon its final preparation, it is also understood that such an approach would require a substantial surplus of drivers such that a driver would be instantly available with every order completed. Such an approach would be prohibitively expensive and would put the QSR operator at a substantial competitive disadvantage. Real-world economics dictate that a slight scarcity of drivers is financially advantageous, placing the burden of managing the delivery queue upon store managers and drivers to “hustle and juggle” orders in an ad-hoc fashion to keep customers satisfied, pizza's delivered while still hot, and drivers from becoming lost.

It is common practice for drivers to take “double” or even “triple” orders when driver availability is low due to a scarcity of drivers or a heavy order volume. It is also common practice to take each order out for delivery in the exact order in which it was placed (FIFO). This approach only works well when sequential double orders are also geographically proximate, but less well when the same two orders are in different parts of the delivery area. In such cases, an experienced manager, driver supervisor, or expert delivery driver with intimate knowledge of the delivery area may amend the FIFO practice to better align the delivery area of a double or multiple delivery. This manual approach is subject to significant approximations of travel time and relevant variables and further presumes that the manager can perform this coordination task without distraction even when the store is at maximum production capacity. In addition, less experienced drivers tend to become lost on multiple deliveries, particularly at night or in inclement weather, such that only the most experienced drivers are eligible for the most efficient routes. Further, the amended FIFO order is sidelined pending the final preparation of the paired order(s) for an indeterminate number of minutes. This supervisory dispatch practice also adds cost to the equation even as it delivery less than ideal performance.

The present invention addresses these problems with an integrated system and automated methods to improve delivery performance and minimize cost. The following description provides an overview of the various functions of the system to disclose steps and computational methods required for a fully optimized QSR food delivery system.

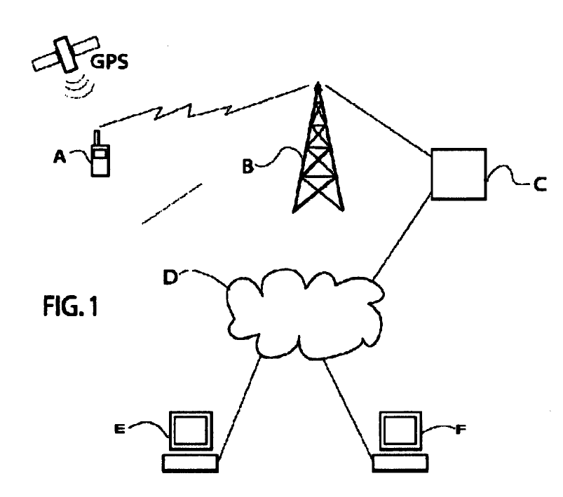

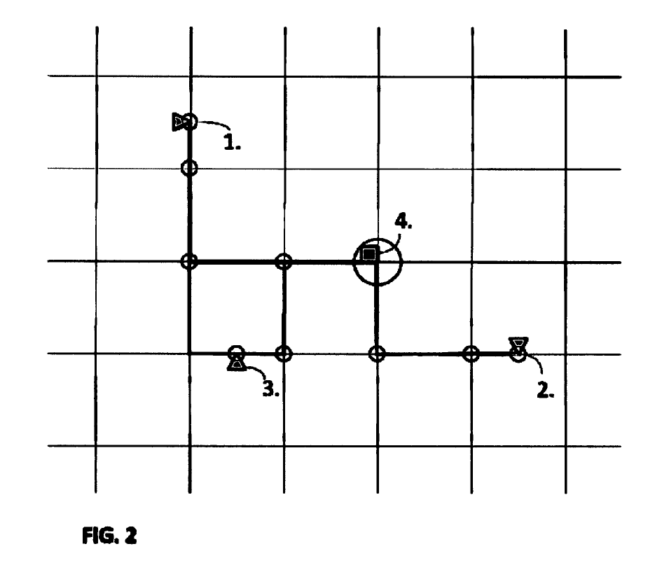

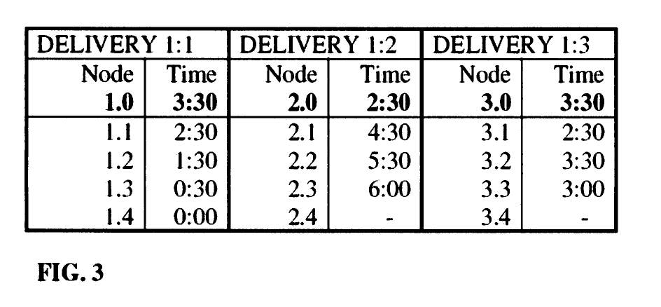

In the preferred embodiment as depicted schematically in FIG. 1, the subject system interfaces with the QSR's Point-of-Sale system such that it receives a sequence of customer orders as they enter the queue. Optimally, the system is also configured to send information to the POS and communicate status information bi-directionally. As each order and customer address is received by the subject invention, it is located geographically within the delivery area and routing analysis is performed with regard to every other delivery address within a dynamic delivery “pairing-window” or approximately 0-20 minutes, but more preferably approximately 7 minutes (ref. FIG. 2, FIG. 3). The delivery window represents the maximum “hold” time that an order might be sidelined pending pairing with one or more paired deliveries for a driver delivery run. The window of orders that might be paired is dynamic such that variations in driver availability and order volume expand or contract the pairing window for associating orders in multiple-delivery runs; this is done algorithmically and with input from predictive variables modeling the diurnal ebb and flow of order activity associated with lunch and dinner delivery volume surge.

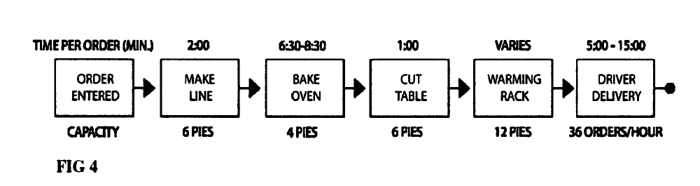

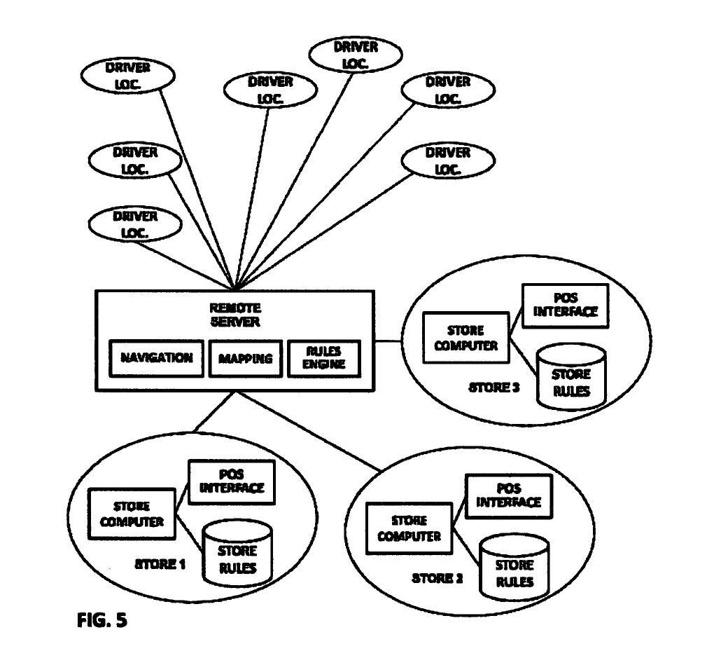

In the case of POS interfaces that have bi-directional information capability, paired orders are further analyzed by order-item. The subject invention identifies any item(s) that impact the sideline time of the first FIFO order in the pairing and flags that item as a priority for the make-line such that it is caused to be placed ahead of its default position in the baking oven (FIG. 4). For example, using a local rules database (FIG. 5) describing preparation times for oven-processed food items particular to that QSR, the subject invention identifies that the large deep-dish pizza in paired order number two is responsible for an additional three minutes of side-line time for the paired order delivery. This item is prioritized on the makeline through communication with the POS such that it is caused to arrive ahead of other FIFO orders in the oven. As such, the geographically paired delivery run is further optimized by three minutes in this example, allowing the driver to dispatch earlier. Under conditions where the pairing window is reduced to the aperture of item bake-time variability, an iterative process that includes the make-line FIFO optimization may be introduced into the pairing algorithm to add additional orders into the pairing-window analysis.

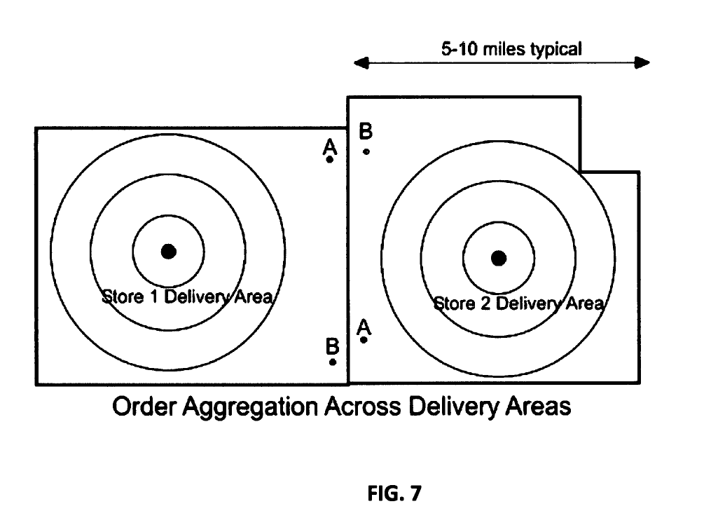

In cases where the subject QSR is directly adjacent to an affiliate store networked with the subject invention, a further optimization analysis may be performed to identify situations where such delivery is near the outer boundaries of the delivery zone common to the affiliate store. Referring to FIG. 7 depicting the described condition, it can readily be seen that by swapping order “B” from each store, further delivery efficiency can be realized. In such cases, the subject invention identifies the proximate adjacency and flags the POS system to enter the appropriate arbitrage and aggregated order reconciliation is accomplished over the subject inventions network server connection or alternately by means internal to the respective POS systems.

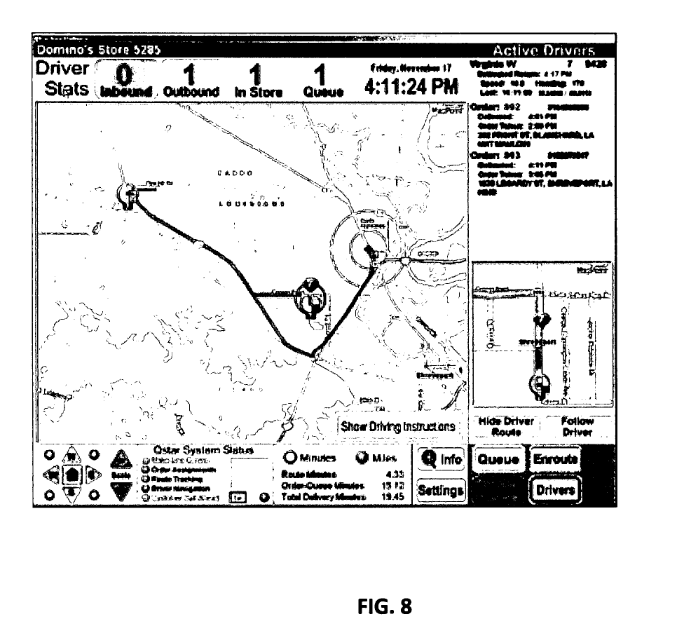

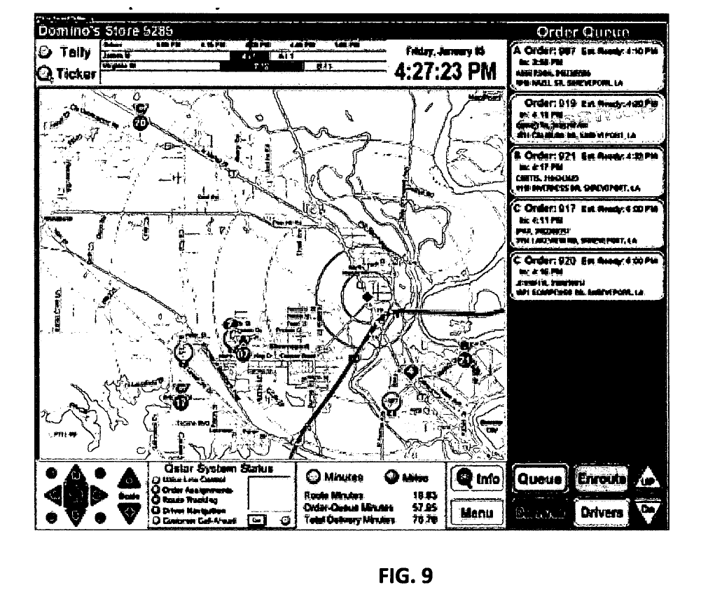

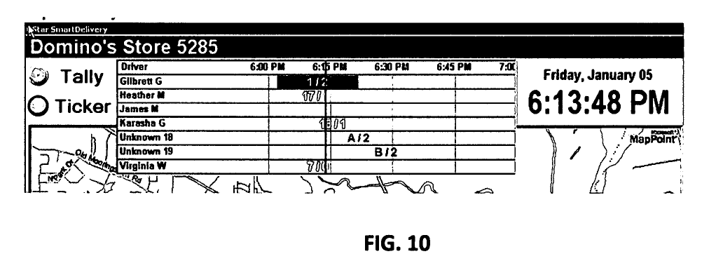

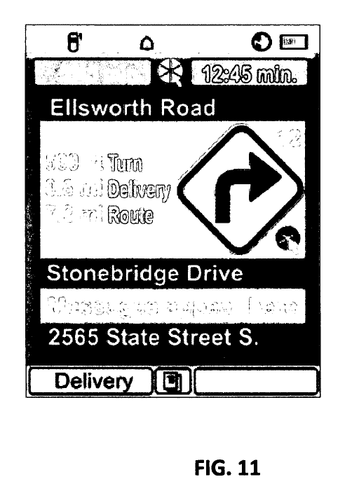

The subject invention works with the QSR's POS system to nominate or assign drivers to specific routes. Routes are displayed on a monitor located near the driver dispatch station allowing drivers to visually prior to departure as depicted in FIG. 8. Once the route selection is dispatched to a driver, the driver may optionally carry a GPS-enabled cellular or wireless device to receive turn-by-turn directions to each delivery address as depicted in FIG. 11. The driver's location during the route may be observed on the in-store computer. The invention detects when the driver is off-course and downloads a new route to the GPS device automatically. FIG. 9 depicts the locations of drivers on their respective delivery routes and provides in-store personnel with driver ETA and other useful information. The dynamic “ticker bar” near the top of the display in FIG. 9 and as detailed in FIG. 10 depicts the status of each driver on a route represented graphically representing the total calculated duration of their run, and the time they are expected to return together with the number of orders being delivered. In the preferred embodiment this ticker bar updates at least 10 times per minute.

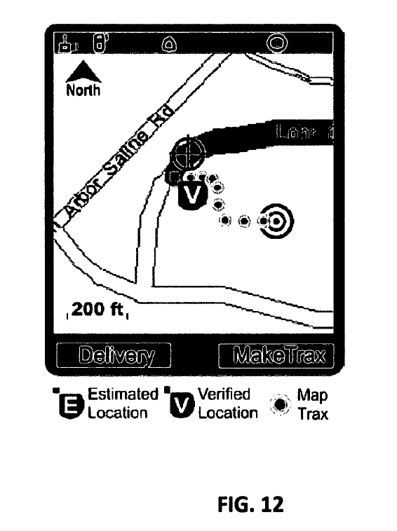

The invention's geographical database of address information may be derived from one or more of the various commercial geo-databases such as MapPoint, Google Maps, etc. Due to the nature of the data collection process a small percentage of these address do not have high-precision latitude longitude information. The subject invention maintains a custom store database of confirmed customer addresses such that the driver can see from the display on the wireless device if the location has been verified by a previous delivery as depicted in FIG. 12. Additionally, some deliveries to campus, corporate or apartment locations may be located some distance from the actual physical street address coordinates. In such cases the subject invention allows the driver to record a series of locations from the street address “gateway” to the delivery door. In the present invention, this trail of geographic breadcrumbs is referred to as MapTrax, and is stored in the separate database as referenced above (ref. FIG. 12).

There are instances where the commercial geographical database does not have a location for the delivery customer's street address, for example, a newly constructed subdivision. The present invention solves this problem by flagging these orders for in-store attention prior to dispatch. The invention's DynaMap feature (FIG. 9, right menu) allows the manager or another experienced staff person to enter the approximate location of the delivery on the monitor, and the system navigates the driver to that location. When the driver locates the address and delivers the order, the actual and precise location is stored in the custom database where it is saved for all subsequent deliveries. The invention will latter recognize the missing street name and direct the driver to that area on the next delivery allowing the driver to again confirm the unique coordinates of that customer. The self-learning database capabilities of MapTrax and Dynamap quickly allow the invention to store and maintain a precise mapping of customer addresses.

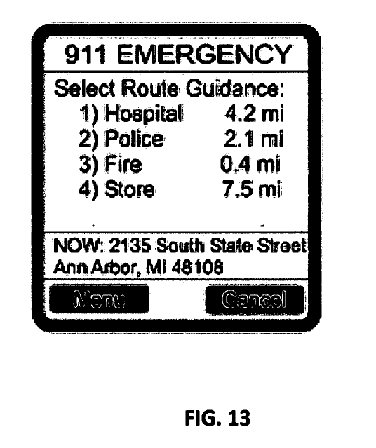

To enhance driver safety, the invention monitors off-course notices from each GPS device and causes an alert on the in-store computer when a specific number of re-routes are issued to a driver possible indicating a car-jacking or similar problem. In addition, the driver may press an emergency key on the device to signal the store of a problem with the delivery. Communication between the device and the store allows the problem to be identified. Should the driver need assistance, the device will provide directions to the nearest police station or hospital as depicted in FIG. 13. In the preferred embodiment, Amber Alert information may be issued to driver's GPS automatically.

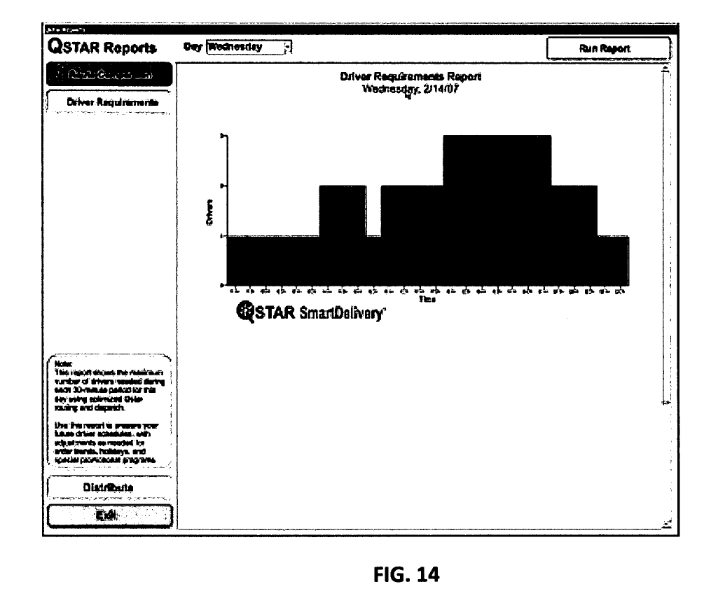

A post-delivery reporting system compares optimal route and delivery guidance with actual results on a daily bases. Various metrics are reported, including a predicative analysis of future driver resources for the same day as depicted in FIG. 14. These data may be used to identify driver performance issues and prepare shift schedules.

Thus is described in general terms the capabilities of the subject invention; additional aspects of the system and methods disclosed herein are enumerated below:

It is an object of the present invention to provide a system and method for the production of local delivery orders that minimizes interrelated bottlenecks in the food preparation, baking, final assembly and driver dispatch processes by adjusting the order queue process thereby improving overall efficiency.

It is an object of the present invention to provide a system and method for the dispatch and routing of local-delivery drivers that reduces the total number of delivery runs by pairing two or more orders into a single delivery run based on route delivery and queue management optimization. The number of multiple-delivery runs may be controlled dynamically to adjust for changing store and driver variables, allowing the store to more or less aggressively conserve expenses.

It is an object of the present invention to provide a system and method for the dispatch and routing of local-delivery drivers that saves time and money by selecting be optimal delivery route for a particular run based on real-time road, weather, and traffic conditions.

It is an intent of the present invention to provide a system and method that integrates the above objectives, each in their respective part, to achieve a state of stable but dynamic workflow and delivery optimization.

It is an object of the present invention to provide a system and method for the dispatch and routing of local-delivery drivers that that reduces operator cost and increases driver's collective earning also increasing overall customer satisfaction.

In one embodiment, a system and method for the production of orders prepared based on the reduction of bottlenecks to alleviate order congestion occurring in production workflow prior to driver dispatch. This method uses production (store) rules to analyze orders entered into the POS system and identify optimization steps in the order preparation process using a combination the rules, delivery information, and geo-location information. For example, based on the workflow depicted above (FIG. 4), two separate orders for three pizzas followed by a third order for a single large multi-topping pizza might be entered in sequence under minute apart. In this illustration, only two of these orders might physically fit into the oven at one time. As determined by the rules engine, by placing the order for the large pizza with a bake time of 8:00 minutes ahead of the second order for three small pizzas which have a bake time of 5:30 minutes, the system will avoid the bottleneck created by having 6 pizzas ready for cutting and boxing within 60 seconds. In this simplified example, the method creates an improved workflow by having three pizzas ready at +5:30 minutes, one pizza ready at +8:00 minutes, and the final order of three pizzas ready at +11:00 minutes. This improved processing also reduces driver congestion at the driver dispatch process. Additionally, it is a feature of the present invention to adjust workflow outcomes based on parametric rules such that if the geo-database indicates that the first order is at the extreme edge of the delivery area whereas the third order is just across the block, the orders would be processed in reverse sequence to increase the average customer satisfaction for all affected customers.

In another embodiment, a system and method for the optimized workflow based on order parameters and delivery time. This method uses dynamic production parameters to analyze orders entered into the POS system and identify optimization steps in the order preparation process using a combination of production rules, delivery information, and geo-location information.

In the above example, an order for four large pizzas in entered followed by an identical order one minute later. Based on oven constrains the second order will not enter the oven until the first order is removed. Based on the workflow example (FIG. 4), the system analyzes both orders and determines that the second order will require a delivery time of 12:00 due to a construction detour whereas the first order is only 2 minutes away. If the orders are processed in sequence, the estimated delivery times are as follows (Sequence A): Order One: make 2:00; bake 6:00; cut 2:00, deliver 2:00=10:00 min. Order Two: taken +1:00; make 2:00; wait 5:00; bake 6:00; cut 2:00, deliver 12:00=28:00 min.

Since the subject invention has a production rule stipulating that all orders must be delivered within 25 minutes, the order sequence is reversed putting the second order in the oven ahead of the first order which results in estimated delivery times as follows (Sequence B): Order One: make 2:00; wait 7:00, bake 6:00; cut 2:00, deliver 2:00=19:00 min. Order Two: taken +1:00; make 2:00; bake 6:00; cut 2:00, deliver 12:00=23:00 min.

In this illustration the total delivery time for outcomes in Sequence B is greater than those obtained in Sequence A, but herein the rule for maximum delivery time for any one customer is maintained. It will be appreciated by experienced operators that these examples are simplified for clarity, and further it should be explicitly understood that the subject invention maintains a plurality of rules that are intended to maintain the highest average customer satisfaction score for the largest possible number of customers and that there might be a competing rule in this instance, which stipulates that first-time customers always be granted the lowest delivery time possible, such that if a first-time customer were also Order One, the order sequence substitution rule would not be implemented, whereas if the first-time customer were Order Two, the substitution would be made with an even greater implementation score than in the first instance.

In another embodiment, a system and method for the optimized dispatch of one or a plurality of local-delivery drivers based on minimizing the total miles or minutes driven for a given number of customer orders. This method reduces total miles driven by pairing two or more separate customer orders for delivery with a single driver on a single delivery run. This method comprises, using automated means, calculating the mileage or delivery time of each customer delivery previously entered into the store's POS system, wherein each route in broken down into a number of sub-segments or nodes, whose adjacency to other delivery addresses are iteratively calculated to identify optimal paired orders.

In the above example, it is determined that the current order volume results in a total delivery time requirement of sixty minutes. With only three available drivers on shift, the system calculates that certain orders must be paired to deliver for orders on two driver runs such that both drivers have a double delivery run thereby allowing all orders to be delivered within 25 minutes of their order entry time.

Referring to FIG. 2, the subject invention analyzes the physical location of each order in the queue sequentially to build an array of mileage/time values against each additional eligible order in the queue which are then used to identify the optimal order pairing addresses. In this example, the route for the first order (Order 1) is defined in terms of route segments or nodes wherein just those intersections which correspond to a one-minute drive time are represented here for simplicity.

Each subsequent order e.g. Order 2, Order 3, are also located and their route segments are identified in turn as constructed in a computer memory array represented in FIG. 3. The nodes are further analyzed to compute the respective travel time from each node of Order 1 to each of the delivery addresses. To illustrate this example we assume that all order processing times are 9:00 minutes and that the orders are received one minute apart. If delivered by a single driver in order sequence, the orders would therefore be ready for delivery after 9 minutes, 10 minutes, and 11 minutes, resulting in a delivery time of 11:30, 20:30 and 27:30 after each order was placed assuming an extra 1:00 minutes for the actual customer payment and 2:00 for in-store check-in/retrieval. However, based on the nodal analysis, the rules engine identifies that Order 1 and Order 3 should be paired in a single delivery run. This adjustment results in a delivery delay of two minutes for the Order 1, but a savings of 3:00 for Order 2, and a savings of 3:30 for Order 3 from the time of customer order placement.

The most granular nodal segmentation corresponds to possible each turning point or roadway that proceeds toward the address under analysis. It will be apparent from the forgoing that computational requirements for this analysis may be intensive, requiring in some cases hundreds or even thousands of nodal locations to be analyzed in real-time. To conserve on computation time, these nodes may be clustered and sub-grouped based on direct mileage point to point based on the computing power of the computer and the number of segments that require analysis. An additional feature of the subject invention is the method to dynamically adjust the array analysis based to available processing power and parse fewer nodes to arrive more quickly to an acceptable solution. The hierarchy of nodal analysis comprises (1) each possible turn; (2) every second turning point, or every third possible turning as required.

The method in this example may further improve the delivery process by evaluating potential pairs with regard to their time of order entry, where rule-driven changes in queue positioning may be effected to further temporally align such potential paired orders.

In another embodiment, a system and method for the optimized dispatch of one or a plurality of local-delivery drivers based on minimizing the total delivery cost for a set number of customer orders based on route information data that includes as applicable, the fastest or shortest route based on selectable parameters including for example, driver compensation rate, fuel or mileage reimbursement cost, posted speed-limits, and real-time traffic conditions.

In yet another embodiment, a system and method for the optimized dispatch of one or a plurality of local-delivery drivers based on a combination of one or more of the above methods to achieve optimal workflow, operational cost efficiency, delivery speed, and customer satisfaction.

In the present invention, the system provides information to store management regarding staffing levels for the driver pool based on the total number of miles required to be driven in the order queue relative to the current cycle of daily business activity. The available driver pool is comprised of active in-store drivers together with drivers entering their shift plus drivers returning to the store augmented by real-time GPS arrival data, minus drivers on break or moving to off-duty. Managers are accustomed to large increases in orders during the lunch and dinner time and orders typically peak twice each day corresponding with this order flux. Store managers staff the driver pool to handle the peak delivery hours and then end driver shifts as they anticipate the driver demand tapering. The present invention monitors the current backlog of delivery miles required as compared with the historical daily trend to indicate that the manager should either advance or delay drivers leaving their shift. The improved system also notifies in-store personnel of changes to the normal order flow due to unusually high or low daily variations on order volume.

The present method and system notifies in-store personnel of changes to the normal order flow due to unusually high or low daily variations from normal order volume based on computed driver-delivery miles.

When a driver completes a run or check-in for a shift, that driver is entered into a queue for delivery assignment. Drivers are assigned deliveries in sequence on a first-in first out basis. Based on the delivery parameters, the drivers are automatically assigned one or more deliveries at which point delivery information which is comprised of driving directions and voice prompts is then automatically downloaded to the driver device.

As the delivery progresses, it is a feature of the present invention that the driver device automatically reports it GPS position to the server which in turn sends location information for display on the in-store computer. The driver device is capable of determining if it is off-course at which time it sends a request to the server to perform a route recalculation, which is then automatically downloaded to the driver device so that driving directions can continue uninterrupted.

When a multiple delivery is underway, it is a feature of the present invention that the directions for the second and subsequent deliveries are automatically downloaded and processed on the driver device so that route guidance proceeds automatically.

The present system provides the capability to display the location of each driver on the in-store computer. Each phase of the driver's delivery process is displayed in a color-coded tally bar so that conditions such as Outbound, Inbound, In-Store, Idle, and Emergency are clearly displayed, or alternately in the form of a ticker bar.

When the driver returns to the store location, the driver device terminates route guidance and may signal that the driver is available for a new delivery run using an interface to the in-store POS computer.

While the present system is contemplated as being useful in the operation of QSR operations, there are numerous other applications where it could also be beneficial. For example, a local delivery company could use it to prevent drivers from being lost and to maintain watch over the safety of the delivery system. The present system and method could also be applied to such diverse fields as taxi and limousine operation, florists, emergency services, inspectors, and governmental agencies.

What is claimed is:

1. A Quick Service Restaurant delivery management system comprised of a network application that provides the most efficient production sequence, order assignment, and routing for each driver delivery trip and further comprised of a remote network server enabling communication with wireless GPS devices, a plurality of in-store POS systems, and the store's customers over the Internet.

2. A delivery management system according to claim 1 wherein said system further comprises means for providing data services to GPS wireless devices to communicate status information, emergency information, and prompt driver responses.

3. A delivery management system according to claim 1 wherein said system further comprises means for that communicates with one or more services providing real-time traffic, weather data, and Amber Alerts.

4. A delivery management system according to claim 1 wherein said system further comprises means for determining the most economical dispatch strategy comprising single or multiple customer orders in a single run based on delivery proximity/route adjacency, driver availability, and store volume using a rules database.

5. A delivery management system according to claim 1 wherein said system further comprises means for allowing orders on the periphery of the delivery area to be shared with affiliate stores such that order-pairing can occur across an aggregated delivery area.

6. A delivery management system according to claim 1 wherein said system further comprises means for analyzing the preparation times of multiple-order items to adjust FIFO production order sequence and thereby minimize set-aside time for any order in the delivery batch using bi-directional communication with the POS system.

7. A delivery management system according to claim 1 wherein said system further comprises means to reduce production bottlenecks based on order volume and item characteristics.

8. A delivery management system according to claim 1 wherein said system further comprises means for visually displaying detailed route information to drivers prior to their departure, and means to allow drivers to accept dispatch assignments.

9. A delivery management system according to claim 1 wherein said system further comprises means for enabling a self-learning geographical database to store and recall new addresses using the entry of an approximate delivery location which is then field verified by the driver at the precise delivery location.

10. A delivery management system according to claim 8 wherein said system further comprises means for displaying Verified versus Estimated delivery locations on the driver's GPS device.

11. A delivery management system according to claim 8 wherein said system further comprises means for recording, storing, and then subsequently recalling the exact GPS trail from the address latitude/longitude gateway to the actual delivery door which might be some distance away in the case of a campus, apartment or corporate location.

12. A delivery management system according to claim 8 wherein said system further comprises means for providing turn-by-turn navigation to delivery drivers equipped with wireless GPS devices such that instructions during highway driving include verbal instructions and large turn arrows but no map (whose interpretation might distract a driver), but where a map graphic does appear within a short distance of the delivery area showing current location, destination, and GPS trail beyond the address gateway.

13. A delivery management system according to claim 1 wherein said system further comprises means for displaying on an in-store computer monitor, the delivery status of each driver as a visual ticker bar which updates at frequent intervals to communicate real-time information including the estimated duration of the delivery as represented by the length of the bar, elapsed time as represented by the position of the current time marker, number of total and currently complete deliveries, as well as estimated return time.

14. A delivery management system according to claim 1 wherein said system further comprises means for providing emergency navigation from the driver's current location to the nearest police station, hospital, emergency room, or other point of service.

15. A delivery management system according to claim 1 wherein said system further comprises the automatic distribution of Amber Alert information to drivers in a manner that requires no human intervention to send, receive, or clear the massage from the device.

16. A delivery management system according to claim 1 wherein said system further comprises methods to minimize the need for the driver to interact physically with the device.

17. A delivery management system according to claim 1 wherein said system further comprises a method for alerting store managers that order activity is trending at a higher or lower rate that typical and suggests the addition of removal of driver and staff resources in real-time.
